(19) United States
(12) Patent Application Publication
(10) Pub. No.: US 2008/0201141 A1
(43) Pub. Date: Aug. 21, 2008

(54) SPEECH FILTERS

(76) Inventors: Igor Abramov, Oceanside, CA (US); Patrick O. Nunally, Escondido, CA (US)

Correspondence Address: I. ABRAMOV, STE. 2B-602, 3529 CANNON ROAD, OCEANSIDE, CA, 92056, US

(21) Appl. No.: 12/031,712

(22) Filed: Feb. 15, 2008

Related U.S. Application Data
(60) Provisional application No. 60/889,938, filed on Feb. 15, 2007.

(51) Int. Cl. G10L 15/00; G10L 15/20

(52) U.S. Cl. 704/234; 704/233; 704/E17.001; 704/E15.039

(57) ABSTRACT

Utterances by a speaker are analyzed by an appropriate computational system. The spoken words are recognized and indexed to their respective analogs which are used to tailor the speech sequence to conform to a pre-determined standard of speech characteristics which could be fixed for a given language or chosen based on the regional characteristics of the said common language target for a communication session. Thusly selected audio sequences are then tailored or synthesized into the normalized characteristics and inserted into the outgoing speech stream such that the resulting audio sequence exhibits reduced speech characteristics deemed undesirable.

### CROSS-REFERENCE TO RELATED APPLICATION

This Application claims the benefit of Provisional Application Ser. No. 60/889,938 filed 15 Feb. , 2007.

### FIELD OF INVENTION

This invention relates generally to enhancements to uttered speech, and particularly to the means of normalizing speech in which a speaker's pronunciation, intonation and/or other speech characteristics are undesirable. Specifically, this invention relates to digital processing techniques applied to auditory sequences which effectively normalize the apparent accent in the speech. This invention in addition relates to digital noise- cancelling techniques utilizing digital processing to increase effective signal-to-noise ratio of verbal communications.

### BACKGROUND

One of the serious problems arising in verbal communications is the presence of diverse accents of individuals speaking a common language. While phonetically the utterances of certain words by an individual may be consistent, their enunciation can make his speech difficult or impossible to understand by others unfamiliar with the speaker's accent. With proliferation of international business, global business functions outsourcing and growth of multinational companies whose offices span divers countries, serious challenges to effective communications arise from dissimilar accents of speakers who may not share a common pronunciation or a common mother-tongue. Another problem arises in voice communications in situations where high ambient noise is present at least on one end of the voice communication link. Such high ambient noise environments may include, but not limited to, a battlefield, a moving vehicle, an industrial plant, and various large assemblages of people, such as parades, celebrations, concerts, etc. In the presence of noise in the incoming speech, a listener will normally strain and try to maximize his attention in the attempt to understand the other party. What he is effectively doing is increasing the processing gain of his cognitive speech recognition mechanism. If the speaker's speech is familiar to the listener, the listener's understanding level will be higher than in the case of unfamiliar speech.

Present invention converts any speaker's speech to a standard pronunciation while simultaneously virtually eliminating background noise.

### PRIOR ART

Processing of speech, both analog and digital, performed for varied purposes is well known in the art. Digital speech compression for transmission bandwidth minimization, noise filtering, frequency shifting are some of the examples of such processing and are well-known in the art.

Speech recognition techniques are also well known in the prior art and tend to focus on complex algorithms to convert speech to text. Likewise, techniques for speech decompression synthesis as well as completely synthetic speech and sentence construction are also well known.

None of the prior art however discloses a speech filter as disclosed and claimed herein wherein a speaker articulates in one language using some of the rules or sounds of another language or dialect, or where his articulation is determined by where he lives and what social groups he belongs to.

Likewise, none of the prior art discloses a noise-cancellation technique for voice communications which is based on speech-recognition techniques of the present invention.

### SUMMARY OF THE INVENTION

In accordance with the present invention utterances by a speaker are analyzed by an appropriate computational system. The spoken words are recognized and indexed to their respective analogs which are used to tailor the speech sequence to conform to a pre-determined standard of speech characteristics which could be adjusted for a given language, or chosen based on the regional characteristics of the said common language target for a communication session. Thusly selected audio sequences are then tailored or synthesized into the normalized characteristics and inserted into the outgoing speech stream such that the spoken audio sequence exhibits reduced speech characteristics which may be undesirable while substantially preserving generalized speech characteristics specific to a speaker, such as tempo, pitch, and overall sentence inflection .

The noise-cancellation features of this invention rely on recognition of the speaker's utterances in the presence of noise and reconstructing them in a way to maximize their comprehension by a listener. Additionally, in the presence of noise at the receiving end of communications, the output speech can be adjusted to maximize its intelligibility.

### OBJECTS AND ADVANTAGES

Generalized objects and advantages of the present invention include: Normalization of speech sequences contained in an audio stream which are phonically in bounds of a predetermined set of parameters, and respectively altering an audio stream which falls outside of the bounds of a predetermined set of parameters, the determination being based on sound sequence and contextual usage.

Reducing computational load on systems resultant from this invention such that these systems can be operated with nominal latency such that users perceive near- or full real-time operation.

Support for a large variety of speech parameters such that users can select normalized output formats based on a common language and/or dialect, or high ambient noise conditions.

Use of speech recognition to effectively remove noise from the output speech by effectively increasing the signal-to-noise ratio with digital speech processing.

Use of speech training to increase accuracy and reduce computational loads of speech altering systems though a unique application of speech recognition technology.

It should be recognized by those skilled in the art that while the normalization of speaker enunciation in audio sequence is used as an illustrative example the modification of syntax, reformatting of sentence structure and/or the use of multiple common parameter sets of common or divers languages is contemplated. While preferred embodiments are shown, they should not be construed as limiting.

### BRIEF DESCRIPTION OF THE DRAWINGS

FIG. 1—Shows a functional block diagram of one embodiment of the invention

FIG. 2—Shows a detailed block diagram of one embodiment of the invention

FIG. 3—Shows a detailed block diagram of the embodiment of the invention for multi-language implementation.

FIG. 4—Shows a detailed block diagram of the operation of the invention on a phoneme level

FIG. 5—Shows a system embodiment of the invention

### DESCRIPTION OF THE PREFERRED EMBODIMENT

This invention requires the input of human speech. Speech can be represented as an analog wave that varies over time and has a smooth, continuous curve. The height of the wave represents intensity (loudness), and the shape of the wave represents frequency (pitch). The continuous curve of the wave accommodates a multiplicity of possible values. It is known in the prior art to convert these values into a set of discrete values, using a process called digitization.

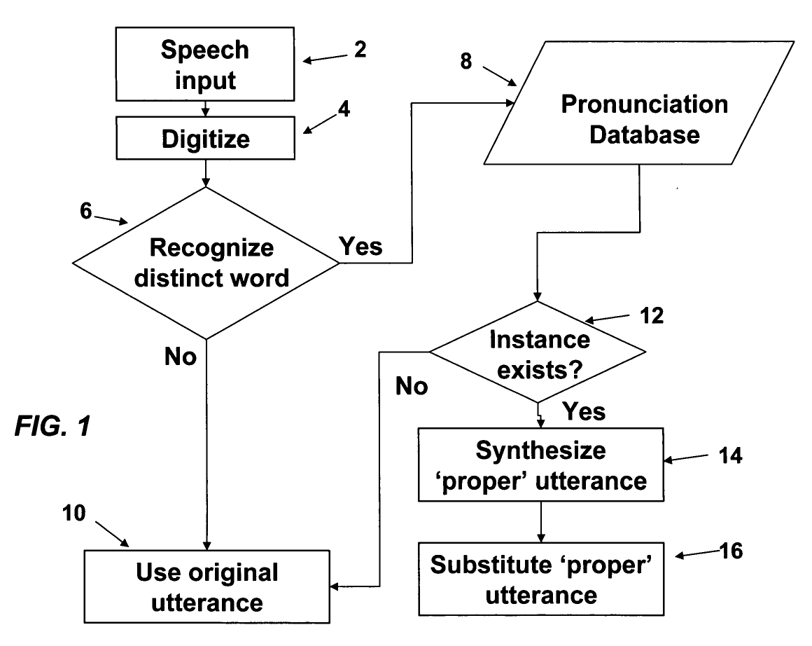

FIG. 1 shows a simplified concept of the invention. Speech is input via process 2 and subsequently digitized in process 4. The speech recognition process 6 attempts to parse the utterances into distinct words and recognize them. If recognition is successful a pronunciation database 8 is queried for the proper pronunciation description instance of the recognized word by process 12. If a proper pronunciation description of the recognized word exists, it is used by process 14 to synthesize the actual ‘proper’ waveform of the word which is substituted into the speech stream by process 16. If, however, the word is not recognized or its recognized but a pronunciation description cannot be found, the original utterance is retained in the output speech stream by process 10.

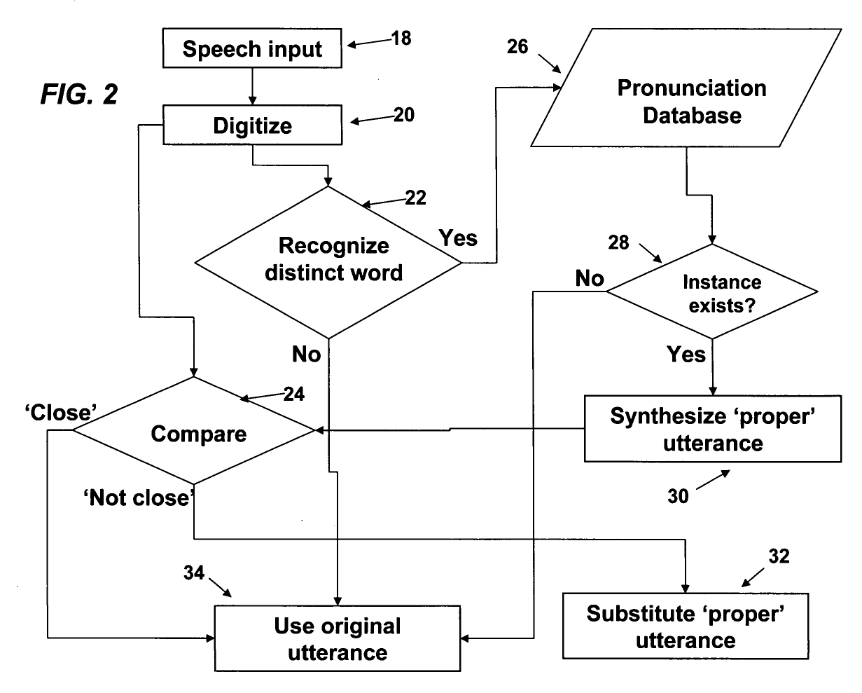

FIG. 2 shows a refinement of the process in FIG. 1 where the speech is input via process 18 and subsequently digitized in process 20. Speech recognition process 22 attempts to parse the utterances into distinct words and recognize them. If recognition is successful pronunciation database 26 is queried for the proper pronunciation description instance of the recognized word by process 28. If a proper pronunciation description of the recognized word exists, it is used by process 30 to synthesize the actual ‘proper’ waveform of the utterance. This synthesized version of the ‘properly pronounced’ word is then compared with the digitized version of the original utterance by process 24 which determines if the two are ‘close’ per the built-in comparison rules. If the two are ‘close’, the original utterance is used without alteration for output via process 34. Otherwise, the ‘properly’ pronounced utterance is substituted into the speech stream by process 32

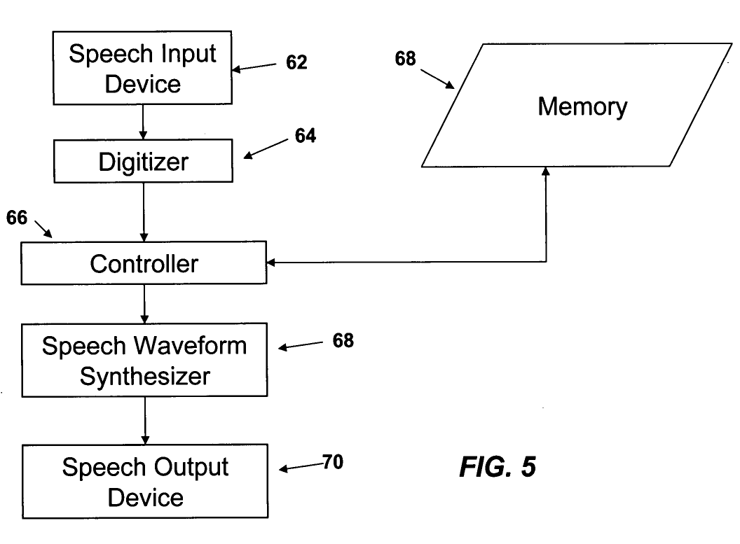

As shown in FIG. 5 when “discrete utterance” information is presented to this invention in analog form via speech input device 62, an analog-digital converter also known as digitizer 64 is used to convert the analog digital signals sampled at a fixed rate into blocks of data such as 260 bits for every set of original samples such as containing 160 units. This invention then provides this digitized voice to a coding algorithm residing in controller 66 and memory 68 selected from a member of the linear predictive analysis-by-synthesis (LPAS) family of coding algorithms. As is the case with all LPAS algorithms, speech is represented using two sets of parameters: information about the Linear predictive coding (LPC) filter (in the form of quantized log area ratios, or Q-LARS) and information about the coded residual signal in the form of quantized Regular Pulse Excited Long Term Prediction (RPE-LTP parameters). The original analog system can be sampled at a differing rate for presentation to a digital speech recognition algorithm. Once the digital speech recognition has completed by controller 66 a conversion of a number of discrete utterances into binary patterns representing one or more words the binary patterns are presented to a synthesizer 68 which converts the binary patterns of words into binary patterns of synthesized speech. This synthesized speech represents an extremely artificial but highly repeatable representation of the original discreet utterances. This interim representation of the deconstructed speech may now be used to alter the reconstruction of the original speech waveforms.

Typical reconstruction is achieved by convolution of the impulse response of the LPC filter with the residual signal and the spectrum of the speech and the waveform can be estimated by adding the spectra of the LPC filter and of the residual. By establishing an algorithmic relationship between the known word pattern, the original voice coded Q-LARS and RPE-LTP parameters, the normalized Q-LARS and RPE-LTP indexed from synthesis and the original digital voice representation can be derived and output via speech output device 70.

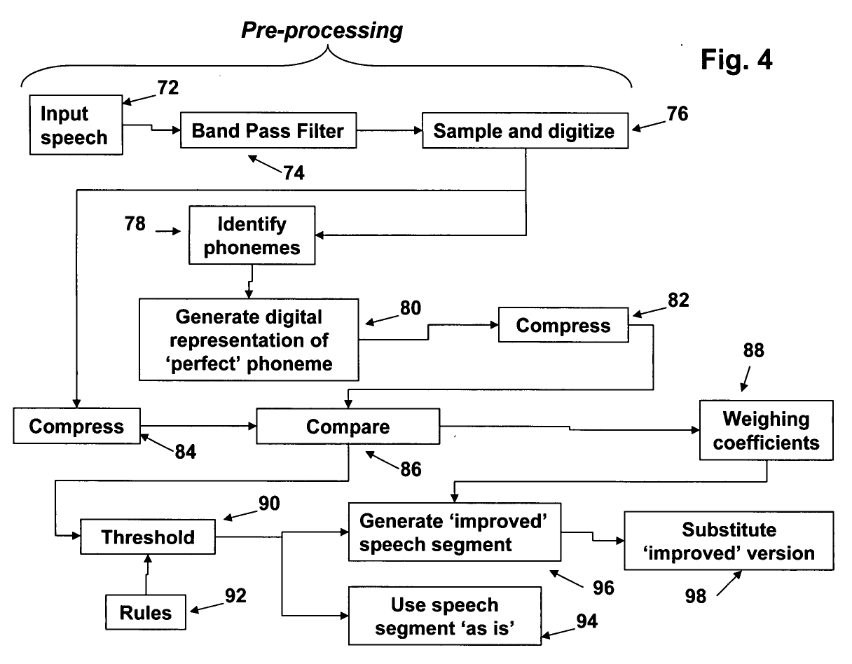

Alternately, as shown in FIG. 4 an analog signal upon input 72 can be repeatedly quantized where each sample results in a set of bits. Before sampling and digitizing process 76, the converter pre-filters the signal via a band -pass filtering process 74 so that most of it lies between 300 and 3400 Hz which is recognized as the frequency band containing most of the human speech information. In addition to sampling speech, the indexing of pauses is used to sample background noises and remove them from the data.

Subsequently the invention compares the sampled sound to known characteristics of human speech and removes obvious noise. The system then locates phonemes via process 78 within the string of incoming values and generates digital representations of pre-determined ‘perfect’ phoneme via process 80. Compression processes 82 and 84 are used on the sampled and digitized speech and ‘perfect phoneme’ representations respectively to decrease the computational load on the system in processing.

Computational process 78 is used to recognize obvious phonemes as well as classification of phonemes based on linguistic bodies of knowledge into which phonemes typically follow others. These conjectures are aided by training of patterns of the current user speech.

Once the system of the current invention has completed conversion of a number of discrete utterances into binary patterns representing one or more phonemes as the binary patterns, it combines multiple phonemes into morphemes and words. Once the probable phoneme, morphemes and context is registered, the indexing of the higher level phoneme/morpheme patterns is performed by the system.

In parallel to the indexing process as described above, the speaker's voice is sampled at a fixed rate into blocks of data such as 260 bits for every set of original samples such as 160 and then coded using an algorithm selected from a member of the linear predictive analysis-by-synthesis (LPAS) family of coding algorithms. As is the case with all LPAS algorithms, speech is represented using two sets of parameters: information about LPC filter (in the form of quantized log area ratios, or Q-LARS) and information about the coded residual signal in the form of quantized Regular Pulse Excited Long Term Prediction (RPE-LTP parameters) all of which are well represented in the prior art.

The normalized speech resultant from the current invention is achieved by remapping the original voice Q-LARS and RPE-LTP parameters based on an indexing of the higher level phoneme/morpheme patterns and a priori knowledge of Q-LARS and RPE-LTP parameters derived from the normalized indexing of phoneme/morpheme patterns. Using the speech recognition the invention forms a notional model of what sound patters are needed. The source code model provides a generalized magnitude of corrective insertion by comparing the coded representation of the speech to equivalent normalized pattern derived from the recognition process.

With the original speech sequence, the temporal locations of speech which is outside of the normalized window and the magnitude of these offsets from the normalized speech target the invention passes portions of the voice without modification when these portions are within the normalized target window in process 94, after applying threshold 90 which in turn is subject to pre-determined rules 92.

If, however, voice inputs extend beyond the normalized threshold 90 of a given language as determined by comparing actual compressed source modeled speech with template source modeled speech as indexed by the voice recognition function, the corrected sequence is substituted instead of the original speech in process 98.

The correction to the speech by process 96 is made by interpolating between the waveform compressed voice sequence and a projected waveform compressed voice sequence which using a quantization table derived from the actual voice and by using pre-determined weighing coefficients 88. This corrected voice sequence can be used directly via process 98, however the degree of offset from the source model will provide an ideal weighting to allow seamless integration into the voice sequence.

### ADDITIONAL EMBODIMENTS

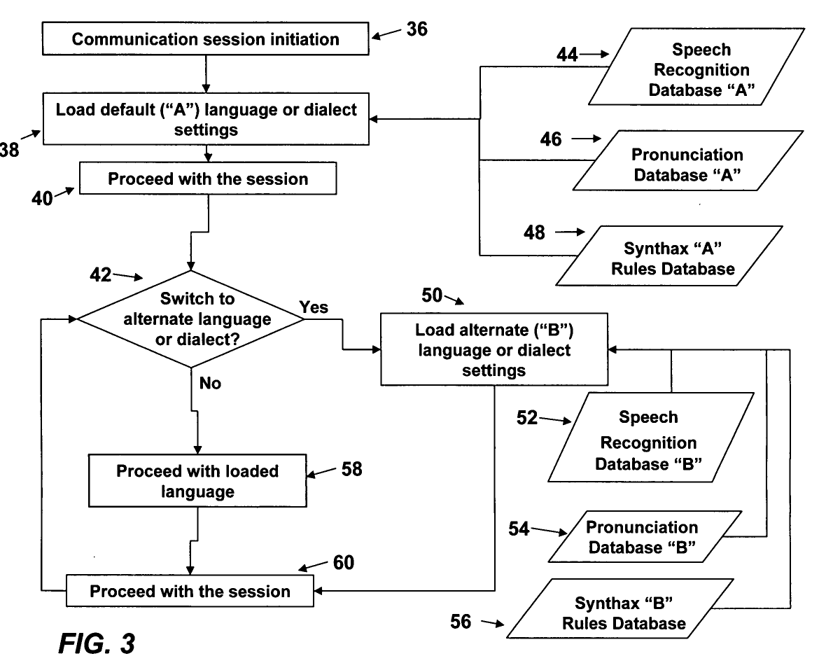

FIG. 3 shows an additional embodiment of the present invention where users are given a choice of several languages or dialects for communications. Upon initiation of communication session via process 36, subsequent process 38 loads default language ‘A’ selection supported by speech recognition database 44, pronunciation database 46 and syntax rules database 48. The communication session then proceeds as described in previous embodiments via a processes 40, 58 and 60. If it's determined via process 42 that an alternate language or dialect is more appropriate, alternative language ‘B’ selection is made via process 50, which is supported by its speech recognition database 52, pronunciation database 54 and syntax rules database 56. The session is ten proceeds in theis language or dialect via process 60.

It is anticipated that one skilled in the art will recognize that the same methods, apparatuses and systems can be used to enhance communications between individuals and/or groups in environments which include, but not limited to ambient noises such as automotive, road, battlefield, industrial and crowd sounds. Present invention converts any speaker's speech to a standard pronunciation while simultaneously virtually eliminates background noise.

Additionally, the system of present invention, by using speech recognition and being trainable for a particular speaker's speech, acts as a ‘familiarizer’ of the speaker's speech, thus removing this burden from the listener. This further enhances speech intelligibility and understanding in high-stress situations. Those skilled in the art will also recognize the application of this invention in public service applications such as but not limited to emergency services, crime tip lines, and social services.

Additionally, persons with various speech impediments, such as lisp, stuttering, stammering, lallation, lambdacisms, cataphasia, etc. would be able to converse more or less normally with others, the only requirement being that their speech be processed by the system of the instant invention, recognized by it, and then re-played. Even whole sentence fragments, such as undesirable utterances and ‘filler’ words can be reduced in occurrence or eliminated, at will.

Although descriptions provided above contain many specific details, they should not be construed as limiting the scope of the present invention. Thus, the scope of this invention should be determined from the appended claims and their legal equivalents.

We claim:

1. A method of adjusting the characteristics of a speaker's voice perceived by a listener or listeners during an interaction between the speaker and the listener or listeners based upon a targeted objective, such method comprising the steps of:
a) referencing a predetermined objective for the adjustment of a speakers voice,
b) retrieving a predetermined set of interaction parametric values based upon the targeted objective for the adjustment of a speakers voice,
c) detecting aspects of the speaker's voice, and
d) modifying speaker's voice perceived by a listener or listeners to the targeted objective based upon the predetermined set of interaction parametric values to produce a spoken voice perceived by the listener or listeners based upon the detected content, wherein said speaker and listener or listeners are different and said listener or listeners only hear the modified voice of the speaker.

2. A system for speech alteration comprising:
a) acquisition of speech signals;
b) algorithmic recognition of speech patterns, and their conversion to distinct phoneme and morpheme representations;
c) algorithmic selection of the appropriate instances of said distinct phoneme and morpheme representations from a plurality of instances residing in said system's memory, said selection process governed by the predetermined objective for the adjustment of a speakers voice;
d) algorithmic alteration of the appropriate instances of said distinct phoneme and morpheme representations from a plurality of instances residing in said system's memory, said alteration process governed by the predetermined objective for the adjustment of a speakers voice;;
f) digital output of altered speech representations stored in system memory.

3. A method of altering spoken speech, comprising:
a) parsing speech input with speech recognition algorithms;
b) identification of portions of the speech input inconsistent with a pre-determined pronunciation objective indexed in part by the parsed speech input;
c) combinatorial processing of the speech input and said pre-determined pronunciation objective;

4. An ambient noise cancelling speech-based communication system, said noise cancellation effected by:
a. accepting audio input;
b. parsing audio input with speech recognition algorithms;
c. identification of portions of the speech input inconsistent with a pre-determined pronunciation objective indexed in part by the parsed speech input;
d. combinatorial processing of the speech input and said pre-determined pronunciation objective.

5. A speech-conversion processing apparatus, comprising:
a) memory storing digital signals representing at least a portion of speech to be converted;
b) a microprocessor executing algorithm to convert a portion of speech to be converted to stored in memory phoneme and morpheme representations; and to algorithmically alter portions of stored speech to be consistent with a set of pronunciation objectives stored in memory;

6. The speech-conversion processing apparatus according to claim 5, wherein the algorithms to convert said portion of stored speech is based in part on speech recognition algorithms.

7. The speech-conversion processing apparatus according to claim 5, wherein a speech-conversion algorithm includes a threshold of acceptable variance between portions of stored speech and the set of pronunciation objectives stored in memory

8. The speech-conversion processing apparatus according to claim 5, wherein the speech-conversion algorithm includes a threshold of unacceptable variance between portions of stored speech and the set of pronunciation objectives stored in memory

9. The speech-conversion processing apparatus according to claim 5, wherein the set of pronunciation objectives stored in memory comprises representations of phoneme and morpheme patterns.

10. The speech-conversion processing apparatus according to claim 5, wherein the microprocessor controls the algorithmic mapping between the storing digital signals representing at least a portion of speech to be converted and the set of pronunciation objectives stored in memory.
